(19) United States
(12) Patent Application Publication
(10) Pub. No.: US 2017/0091766 A1
(43) Pub. Date: Mar. 30, 2017

(54) TRANSACTION SYSTEM

(71) Applicant: MasterCard Asia/Pacific Pte Ltd, Singapore (SG)

(72) Inventors: Vijin Venugopalan, Singapore (SG); Benjamin Charles Gilbey, Singapore (SG); Benjamin Ong, Singapore (SG)

(21) Appl. No.: 15/275,829

(22) Filed: Sep. 26, 2016

(30) Foreign Application Priority Data
Sep. 28, 2015 (SG) 10201508055Y

(51) Int. Cl. G06Q 20/40; G06Q 20/38; G06Q 10/08

(52) U.S. Cl. CPC G06Q 20/401; G06Q 10/083; G06Q 20/382; G06Q 2220/00

(57) ABSTRACT

A transaction system for performing a transaction relating to delivery of goods to a user by a delivery vehicle, the transaction system including at least one electronic payment processing device that receives a user payment request from a client device of the user, the user payment request being indicative of delivery parameters received by the client device from a delivery vehicle processing device, the delivery parameters being indicative of the respective delivery; and an account indication indicative of a user account associated with the user. The processing device determines a payment token associated with the user account and at least one of the delivery parameters, provides the payment token to the client device, the client device providing the payment token to a merchant processing device via the delivery vehicle processing device, receives the payment token from the merchant processing device and, uses the payment token to selectively authorise the transaction, so that the goods are selectively provided to the user depending on the outcome of the authorisation.

### CROSS REFERENCE TO RELATED APPLICATION

This application is a U.S. National Stage filing under 35 U.S.C. §119, based on and claiming benefit of and priority to SG Patent Application No. 10201508055Y filed Sep. 28, 2015.

### BACKGROUND OF THE INVENTION

The present invention relates to a transaction system for performing a transaction relating to delivery of goods to a user by a delivery vehicle, and in one example, by an at least partially autonomous vehicle.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Some businesses are structure to sell and deliver goods or services to users. For example, merchants offering mail order catalogues have been operating for many years where users receive a catalogue advertising a variety of products and may opt via post or over the phone to purchase one or more the products for delivery to their address. Typically, transactions associated with the purchase of these products involve the following steps:
(a) the user selecting one or more products from the catalogue for purchase;
(b) the user placing an order for the products over the telephone or via the post, including providing an address for delivery and their credit card details, a bank cheque, money order, or other acceptable means;
(c) the merchant receiving the order and debiting the credit card, depositing the cheque, money order, or otherwise processing the payment;
(d) the merchant dispatching the product(s) to the user's address via post or courier; and,
(e) the user receiving the products at the address.

However, these type of transactions suffer from a number of drawbacks. For example, in the event the user's order is intercepted by a third party, the payment details (such as a cheque, cash or credit card number) may be stolen and used to conduct fraudulent transactions. Moreover, the products may be lost in transit as an unauthorised party may misappropriate the products in transit, or by fraudulently taking delivery at the user's address. Similarly, the goods may inadvertently be delivered to the incorrect address.

These issues can result in large costs accumulating for the merchant, user, and in the case of fraudulent credit cards, a credit card issuer.

In recent times, merchants have begun offering online ordering of products (e.g. online shopping). Typically, the ordering process in these systems is similar to the abovementioned process, however orders are submitted over the Internet, and payments finalised at the time of placing an order. Whilst online payments may offer additional security over previous mail order systems (e.g. via encryption of credit card details, PayPal™, Mobile Wallets, etc.), products may still be lost or stolen in transit, or delivered incorrectly, costing the merchants and users time and money.

Some merchants and couriers, such as Amazon™ and DHL Parcelcopter™, have recently proposed to use drones for delivery of products. For example, Amazon Prime Air™ is a conceptual drone-based delivery system for Amazon™ products. However, such systems typically only provide passive delivery of pre-purchased products and therefore products are still at risk of being mis-delivered or stolen at the point of delivery.

Whilst some couriers offer services which require users to present identification (such as a driver's licence) upon delivery of a package, these services are typically costly and can be particularly inconvenient if the user is not at the address at the time of attempted delivery. Typically in these situations, the user is then required to reschedule delivery and/or collect the package from a depot, adding to the inconvenience.

### SUMMARY OF THE PRESENT INVENTION

In one broad form the present invention seeks to provide a transaction system for performing a transaction relating to delivery of goods to a user by a delivery vehicle, the transaction system including at least one electronic payment processing device that:
a) receives a user payment request from a client device of the user, the user payment request being indicative of:
   i) delivery parameters received by the client device from a delivery vehicle processing device, the delivery parameters being indicative of the respective delivery; and,
   ii) an account indication indicative of a user account associated with the user;
b) determines a payment token associated with the user account and at least one of the delivery parameters;
c) provides the payment token to the client device, the client device providing the payment token to a merchant processing device via the delivery vehicle processing device;
d) receives the payment token from the merchant processing device; and,
e) uses the payment token to selectively authorise the transaction, so that the goods are selectively provided to the user depending on the outcome of the authorisation.

Typically the at least one electronic payment processing device provides a payment authorisation response to the merchant processing device, the merchant processing device using the payment authorisation response to cause the delivery vehicle to selectively provide the goods to the user depending on the outcome of the authorisation.

Typically the at least one electronic payment processing device:
a) receives a merchant payment request including:
   i) at least one delivery parameter; and,
   ii) the payment token;
b) compares the at least one delivery parameter of the merchant payment request to a corresponding delivery parameter of the user payment request; and,
c) selectively authorises the transaction based on results of the comparison.

Typically the at least one electronic payment processing device authorises the transaction by:
a) determining the user account using the payment token; and,
b) causing the user account to be debited in accordance with the payment amount.

Typically the at least one electronic payment processing device sends an authorisation request to an issuer, the authorisation request including an indication of the user account and the payment amount, thereby causing the issuer to debit the user account by the payment amount.

Typically the at least one electronic payment processing device receives the payment token from the merchant processing device via at least one of:
a) a payment gateway processing device; and,
b) an acquirer processing device.

Typically the at least one electronic payment processing device:
a) retrieves a previously stored unique payment token;
b) generates a new unique payment token;
c) associates the payment token with the user account and the at least one delivery parameter; and,
d) generates a payment token based on the user account and the at least one delivery parameter.

Typically the client device executes a merchant application and a payment application, and wherein:
a) the merchant application:
   i) receives the delivery parameters; and,
   ii) provides the delivery parameters to the payment application; and,
b) the payment application:
   i) generates the user payment request;
   ii) provides the user payment request to the at least one payment processing system;
   iii) receives the payment token; and,
   iv) provides the payment token to the delivery vehicle processing device.

Typically the client device:
a) receives the delivery parameters from the delivery device using a first wireless communications protocol; and,
b) provides the payment token to the delivery device using a second wireless communications protocol.

Typically the first wireless communications protocol includes Bluetooth™ Low Energy (BLE) protocol.

Typically the second wireless communications protocol includes Near Field Communication (NFC) protocol.

Typically the at least one payment processing device is part of a host card emulation system.

Typically the delivery parameters include at least one of:
a) a delivery vehicle identifier associated with the delivery vehicle;
b) a merchant identifier associated with the merchant;
c) a payment amount;
d) a delivery destination;
e) a delivery time; and,
f) a recipient indication indicative of at least one of the user and the client device of the user.

In one broad form the present invention seeks to provide a method for performing a transaction relating to delivery of goods to a user by a delivery vehicle, the method including:
a) receiving a user payment request from a client device of the user, the user payment request being indicative of:
   i) delivery parameters received by the client device from a delivery vehicle processing device, the delivery parameters being indicative of the respective delivery; and,
   ii) an account indication indicative of a user account associated with the user;
b) determining a payment token associated with the user account and at least one of the delivery parameters;
c) providing the payment token to the client device, the client device providing the payment token to a merchant processing device via the delivery vehicle processing device;
d) receiving the payment token from the merchant processing device; and,
e) using the payment token to selectively authorise the transaction, so that the goods are selectively provided to the user depending on the outcome of the authorisation.

In one broad form the present invention seeks to provide a transaction system for performing a transaction relating to delivery of goods to a user by a delivery vehicle, the transaction system including a delivery vehicle processing device of the delivery vehicle that:
a) provides delivery parameters to a client device, the delivery parameters being indicative of the respective delivery;
b) receives a payment token from the client device, wherein the client device obtains the payment token from at least one payment processing device using the delivery parameters and an account indication indicative of a user account associated with the user, the payment token being associated with the user account and at least one of the delivery parameters;
c) provides the payment token to a merchant processing device, the merchant processing device obtaining a payment authorisation response from the at least one payment processing device using the payment token;
d) receives a delivery notification from the merchant processing device in response to the payment authorisation response; and,
e) controls the delivery vehicle in accordance with the delivery notification to selectively provide the goods to the user depending on the outcome of the authorisation.

Typically the delivery vehicle processing device:
a) provides the delivery parameters from the delivery device using a first wireless communications protocol; and,
b) receives the payment token to the delivery device using a second wireless communications protocol.

Typically the first wireless communications protocol includes Bluetooth™ Low Energy (BLE) protocol.

Typically the second wireless communications protocol includes Near Field Communication (NFC) protocol.

Typically the delivery vehicle processing device receives the payment token from the client device based on a proximity of the delivery device and the client device.

Typically the delivery vehicle processing device provides the delivery parameters to the client device based on a proximity of the delivery device and the client device.

Typically the delivery vehicle processing device communicates with a merchant application executed by the client device to determine if the user is an intended recipient.

Typically the delivery vehicle processing device receives at least some delivery parameters from the merchant processing device, including:
a) a payment amount;
b) a delivery destination; and,
c) a recipient indication indicative of at least one of the user and the client device of the user.

Typically the delivery vehicle is an at least partially autonomous unmanned aerial vehicle.

In one broad form the present invention seeks to provide a transaction system for performing a transaction relating to delivery of goods to a user by a delivery vehicle, the transaction system including a client device that:
a) receives delivery parameters from a delivery vehicle processing device of the delivery vehicle, the delivery parameters being indicative of the respective delivery;
b) provides a user payment request to at least one payment processing device, the user payment request being indicative of:
   i) the delivery parameters; and,
   ii) an account indication indicative of a user account associated with the user;
c) receives a payment token from the at least one payment processing device, the payment token being associated with the user account and at least one of the delivery parameters; and,
d) transfers the payment token to the delivery vehicle processing device, the delivery vehicle processing device transferring the payment token to a merchant processing device, the merchant processing device using the payment token to obtain a payment authorisation response from the at least one payment processing device and cause the delivery vehicle to selectively provide the goods depending on the outcome of the authorisation.

Typically the client device executes a merchant application and a payment application, and wherein:
a) the merchant application:
   i) receives the delivery parameters; and,
   ii) provides the delivery parameters to the payment application; and,
b) the payment application:
   i) generates the user payment request;
   ii) provides the user payment request to the at least one payment processing system;
   iii) receives the payment token; and,
   iv) provides the payment token to the delivery vehicle processing device.

In one broad form the present invention seeks to provide a transaction system for performing a transaction relating to delivery of goods to a user by a delivery vehicle, the transaction system including:
a) a merchant processing device;
b) at least one payment processing device;
c) a delivery vehicle including a delivery vehicle processing device; and,
d) a client device of the user, wherein in use:
   i) the delivery vehicle processing device provides delivery parameters to the client device, the delivery parameters being indicative of the respective delivery;
   ii) the client device provides a user payment request to the at least one payment processing device, the user payment request being indicative of:
      (1) the delivery parameters; and,
      (2) an account indication indicative of a user account associated with the user;
   iii) the at least one payment processing device:
      (1) determines a payment token associated with the user account and at least one of the delivery parameters;
      (2) provides the payment token to the client device;
   iv) the client device provides the payment token to the delivery vehicle processing device;
   v) the delivery vehicle processing device provides the payment token to the merchant processing device;
   vi) the merchant processing device provides the payment token to the at least one payment processing device;
   vii) the at least one payment processing device:
      (1) uses the payment token to selectively authorise the transaction; and,
      (2) provides a payment authorisation response to the merchant processing device;
   viii) the merchant processing device uses the payment authorisation response to provide a delivery notification to the delivery vehicle processing device; and,
   ix) the delivery vehicle processing device controls the delivery vehicle in accordance with the delivery notification to selectively provide the goods to the user depending on the outcome of the authorisation.

It will be appreciated that the broad forms of the invention can be used in conjunction, interchangeably and/or independently, and reference to separate broad forms in not intended to be limiting.

### BRIEF DESCRIPTION OF THE DRAWINGS

An example of the present invention will now be described with reference to the accompanying drawings, in which:

FIG. 1 is a schematic diagram of an example of a transaction system for performing a transaction relating to delivery of goods to a user by a delivery vehicle;

FIG. 2 is a flow chart of an example of a method for performing a transaction relating to delivery of goods to a user by a delivery vehicle;

FIG. 3 is a schematic diagram of a further example of a transaction system for performing a transaction relating to delivery of goods to a user by a delivery vehicle;

FIG. 4 is a dataflow diagram of example data flow in the transaction system of FIG. 3;

FIG. 5 is a dataflow diagram of a further example of data flow in the transaction system of FIG. 3;

FIG. 6 is a schematic diagram showing components of an example client device of the transaction system shown in FIG. 1;

FIG. 7 is a schematic diagram showing components of an example delivery vehicle processing device of the transaction system shown in FIG. 1; and,

FIG. 8 is a schematic diagram showing components of an example payment processing or merchant processing device of the transaction system shown in FIG. 1.

### DETAILED DESCRIPTION OF THE PREFERRED EMBODIMENTS

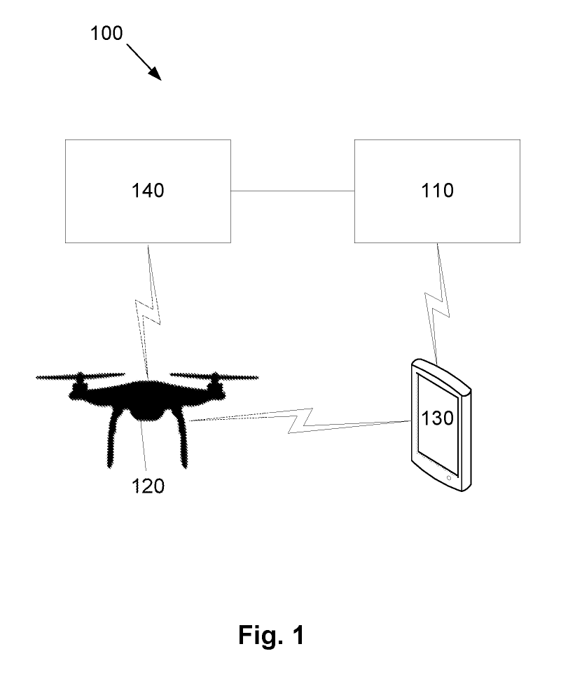

An example of a transaction system for performing a transaction relating to delivery of goods to a user by a delivery vehicle will now be described with reference to FIG. 1.

In this example, the transaction system includes a merchant processing device 140, one or more payment processing devices 110, a delivery vehicle including a delivery vehicle processing device 120, and a client device 130 of the user.

The merchant processing device 140 may include any suitable processing device, such as a computer system, server(s), personal computer, or the like. Similarly, the payment processing device(s) 110 may also include any suitable processing device such as computer system(s), servers(s), and/or may be composed of a number of different processing systems. In any event this will be discussed in more detail below.

The delivery vehicle may include any suitable vehicle for delivery of the goods, and in some examples the delivery vehicle is an unmanned and/or autonomous vehicle. In the preferred embodiment, the delivery vehicle is an at least partially unmanned aerial vehicle (UAV), also referred to as a drone. However, this is not intended to be limiting and the delivery vehicle could include any vehicle, such as a car, van, lorry or the like. Additionally, the delivery vehicle processing device 120 includes any device suitable for associating with the delivery vehicle, and may include a microprocessor, microchip processor, or any other electronic device, system or arrangement, typically with one or more external interfaces, and this will be described in more detail below. The delivery vehicle processing device 120 could also be part of or interface with an existing vehicle guidance or control system.

The client device 130 typically includes a mobile device, such as a tablet or smartphone, however may also include any suitable processing system, and this will also be described in more detail below.

In addition, it will be understood that reference to “goods” may include a reference to goods or services. For example, a delivery vehicle may provide delivery of a service such as transporting a user/package to another location, or any other suitable service which may be provided by a delivery vehicle.

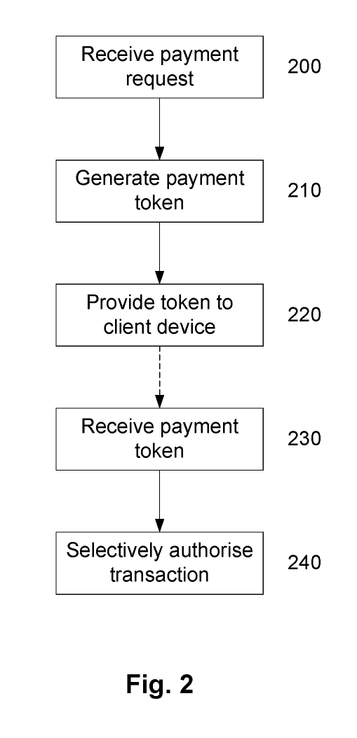

A method of performing a transaction relating to delivery of goods to a user by a delivery vehicle will now be described with reference to FIG. 2. In this example, the method is described from the perspective of actions performed by the electronic payment processing device 110 of the transaction system 100 shown in FIG. 1.

At step 200, the payment processing device 110 receives a user payment request from the client device 130 of the user. The user payment request could be of any suitable form, but is typically at least indicative of delivery parameters received by the client device 130 from the delivery vehicle processing device 120, and an account indication indicative of a user account associated with the user. In this regard, the delivery parameters are used to identify the respective delivery and typically include one or more of a delivery vehicle identifier associated with the delivery vehicle, a merchant identifier associated with the merchant, and a payment amount. Additionally, the delivery parameters may optionally include one or more of a delivery destination, a delivery time, and a recipient indication indicative of at least one of the user and the client device of the user.

The account indication may be of any suitable form which is indicative of the user account, and in some examples is a user account identification number. However, more typically the account indication is encrypted using hardware and/or software (such as a Secure Element (SE)), and/or is a reference to a user account. For example, if the payment processing device is implementing Host Card Emulation (HCE), the indication refers to user account information stored in a cloud based computing environment, and can be based upon at least one of limited use key(s), token(s), device fingerprinting and/or transaction risk analysis, as will be understood by persons skilled in the art.

At step 210, the payment processing device determines a payment token associated with at least one of the delivery parameters and the user account. In some instances, this is achieved by generating a payment token, however may also be achieved by retrieving a previously generated token, as will be discussed further below. The payment token could be associated with one or more of the delivery parameters and the user account in any suitable manner, such as through an appropriate mapping or by encoding some or all of the delivery parameters and the user account within the payment token.

The payment processing device 110 provides the payment token to the client device at step 220, allowing the client device 130 to provide the payment token to a merchant processing device 140, via the delivery vehicle processing device 120. Thus, upon receipt and optionally following suitable user interaction, such as performing a “tap to pay” interaction with part of the delivery vehicle processing device 120, the client device 130 transfers the payment token to the delivery vehicle processing device 120, which in turn forwards this to the merchant processing device 140.

At step 230, the payment processing device 110 receives the payment token from the merchant processing device 140. In some examples, this step occurs in response to the client device 130 passing the payment token to the merchant processing device 140 via the delivery vehicle processing device 120. Thus, step 230 may occur at any time following step 220, as shown by the dashed line in FIG. 2, and in some examples occurs in accordance with an action by the user, such as a user initiated transfer of the payment token to the delivery vehicle processing device 120. In any event, this is discussed further below.

At step 240, the payment processing system 110 uses the payment token to selectively authorise the transaction, so that the goods are selectively provided to the user depending on the outcome of the authorisation. Thus, for example, in the event the transaction is approved the goods are provided to the user, and conversely if the transaction is declined typically the goods are retained by the delivery vehicle.

The abovementioned example therefore provides a transaction system 100 relating to delivery of goods where payment is finalised upon arrival of the delivery vehicle, and where user account details are secured using a payment token.

Accordingly the above described system 100 provides a number of advantages.

As the delivery vehicle processing device 120 in this example accepts payment for the goods at the point of delivery, this ensures that the correct goods are delivered to the correct user. This reduces the risk of accidental delivery to an incorrect user/location, and/or that the goods will be misappropriated by a third party. A reduction in the loss or theft of goods in turn reduces costs for the merchant as well as ensuring peace of mind for the user.

Additionally, the use of a payment token ensures that the delivery vehicle does not have direct access to the user's account information which reduces the risk that the account information will be reused in unauthorised transactions. Moreover, as the token is associated with both delivery parameters and the user account information, in the event the token is misappropriated by a third party it will be of limited use, and could not be used to finalise other payment transactions not associated with that vehicle. These benefits further minimise loss of funds experienced by the merchant, client and/or an account issuer (such as a banking institution) through stolen credentials.

A number of further features will now be described.

In one example, the payment processing device 110 provides a payment authorisation response to the merchant processing device 140, the merchant processing device 140 using the payment authorisation response to cause the delivery vehicle to selectively provide the goods to the user depending on the outcome of the authorisation. Payment authorisation may be provided in any suitable manner from the payment processing device 110 to the merchant processing device 140. In one example, once a payment is deemed authorised by an issuer of the user account (such as associated with a banking institution), an authorisation code is provided to an acquirer via a card network (such as Visa™, MasterCard™, or the like), where the acquirer authorises the payment using the authorisation code and provides an authorisation response to the merchant, optionally via a payment gateway. It will be appreciated that in this example the payment processing device 110 may include a number of processing devices associated with each of the issuer, acquirer, card network and payment gateway, or alternatively, the payment processing device 110 may be any one or more of these entities and this will be discussed further below. Additionally, whilst this example describes separate processing devices, it will be appreciated that one or more of the devices may be virtual.

In a further example, the payment processing device 110 receives a merchant payment request including one or more delivery parameters and the payment token, compares the at least one delivery parameter of the merchant payment request to a corresponding delivery parameter of the user payment request, and selectively authorises the transaction based on results of the comparison. Thus, the payment processing device 110 may achieve this by using the delivery parameters in the merchant payment request to access an indication of the originally generated payment token comparing this to the payment token received as part of the merchant payment request to ensure that these match. This process could include direct comparison of all or part of the payment tokens, or by at least partially decrypting, decoding and/or demapping the payment token in order to perform the comparison. In some instances, this comparison is undertaken by the payment processing system 110 including a card network (such as Visa™, MasterCard™, or the like), where the card network at least partially utilises a protocol such as MasterCard™ Digital Enablement Service (MDES), however this is not essential.

In some instances, the payment processing device 110 authorises the transaction by determining the user account using the payment token, and causing the user account to be debited in accordance with the payment amount. In one particular embodiment, the payment processing device 110 includes a card network (such as described above, and in more detail below) which detokenises the payment token, for example, de-mapping/decoding/decrypting the payment token to a user account identifier (such as a personal account number (PAN)). The detokenised PAN may then be used in order to request an issuer to debit the user's account in accordance with the transaction, as will be discussed below.

In one example, the payment processing device 110 provides a payment authorisation to an issuer, the payment authorisation including an indication of the user account and the payment amount, thereby causing the issuer to debit the user account and credit a merchant account. In this regard, the issuer may debit the user account in accordance with the EMV (Europay™ Mastercard™ Visa™) protocol, which is known in the art and will not be discussed further here. In one example, the issuer is not directly associated with the merchant account (for example, in the event the merchant account is associated with a different issuer (or different banking institution)). In this instance, the issuer indirectly causes the merchant account to be credited, for example, by performing/authorising a debit of the user account. In any event, these steps may be performed in accordance with the EMV protocol.

The payment processing device may receive the payment token from the merchant processing device 140 via a payment gateway processing device or an acquirer processing device. In some instances this is in accordance with the EMV protocol, however this is not essential. As discussed above, optionally the payment gateway and/or acquirer processing devices may form part of the payment processing device. In a further example, the payment gateway and/or acquirer processing device may be implemented as a virtual environment on the payment processing device. In some instances, the payment token may be provided by the delivery vehicle processing device to the payment gateway processing device and/or acquirer processing device via a redirection provided by the merchant processing device 140.

In respect of determining the payment token, as discussed above the payment processing device 110 may achieve this in any suitable manner including retrieving a previously stored unique payment token, generating a new unique payment token, associating the payment token with the user account and one or more delivery parameters, and generating a payment token based on the user account and one or more delivery parameters.

For example, one or more previously stored unique payment tokens may be provided in a store, such as a database or memory, and the payment token is determined by retrieving one of the previously stored payment tokens. Alternatively, a new unique payment token may be generated by generating a random number, pseudo-random number, or the like. Association of the payment token with the identifier and account may be performed in accordance with a mapping algorithm, and generation based upon the delivery parameter(s) and user account may be achieved using an encryption or encoding algorithm.

It will be appreciated that the payment token may be determined using a hybrid approach which combines one or more of the above determination methods, for example, retrieving a previously stored unique token and associating that unique token with the user account and delivery parameter(s).

In any event, the process of determining the payment token typically at least partially substitutes the user account and delivery parameter(s) with a non-sensitive equivalent, such that an unauthorised reversal of the substitution is difficult for a third party to achieve. In some instances a portion of the delivery identifier and/or user account information is included in the payment token, however this is not essential. For example, the last four digits of a user's credit card account may remain in the payment token in order to enable the merchant to easily identify the user's account, for example, in order to process a return of the goods.

In one example, the client device 130 executes a merchant application and a payment application. In this regard, the merchant application receives the delivery parameters and provides the delivery parameters to the payment application. The payment application generates the user payment request, provides the user payment request to the payment processing system 110, receives the payment token, and provides the payment token to the delivery vehicle processing device.

In this regard, the terms merchant application and/or payment application may refer to an application, such as a mobile “app”. Alternatively, the terms may refer to a web browser on the client device 130 which accesses pages published by the merchant processing device 140 and/or pages published by a party managing the functions performed by the payment application (such as an issuer, banking institution, or unrelated third party such as Google Wallet™, Apple Pay™, Samsung Pay™, Android Pay™, PayPal™, Amazon Payments™, or the like).

Thus, the merchant application may include any suitable application for performing the abovementioned steps, and in some examples includes an application capable of handling the ordering of goods. In this respect the merchant application may be associated with a single merchant, or may be a third party application where the merchant is one of many trading on the merchant application. Thus, examples of merchant applications may include merchant specific applications such as online shopping websites/applications offered by Wal-mart™, Target™, or the like, or alternatively websites/applications hosting multiple merchants such as eBay™, Amazon™, etc.

Similarly, the payment application may include any suitable application for performing the abovementioned steps, and in some examples includes a mobile wallet application, where examples include Google Wallet™, Apple Pay™, Samsung Pay™, Android Pay™, PayPal™, Amazon Payments™, and the like. In some examples, the mobile wallet application includes an indication of each of the user accounts associated with the user (which may be one or multiple accounts), and these may be provided in the mobile wallet in accordance with a Secure Element (SE) or Host Card Emulation (HCE) protocol or hybrid of the two. Thus, in one example, the payment processing device 110 is part of a Host Card Emulation (HCE) system. In any event, merchant and payment applications will be discussed further below.

In one example, the client device 130 receives the delivery parameters from the delivery device using a first wireless communications protocol, and provides the payment token to the delivery device using a second wireless communications protocol. Whilst the first and second wireless communications protocols may be the same, in the preferred embodiment the first wireless communications protocol includes Bluetooth™ Low Energy (BLE) protocol and the second wireless communications protocol includes Near Field Communication (NFC) protocol.

In some examples, the transaction may be preauthorised, such as, prior to the dispatch of the goods via the delivery vehicle. Pre-authorisation may be performed in any suitable manner, and in one example, in accordance with known pre-authorisation methods according to the EMV protocol which will not be discussed further here. In any event, if pre-authorisation is performed, the payment processing device 110 may optionally authorise the payment in accordance with pre-authorisation credentials, and in one example this may include comparing at least a portion of the payment token (such as, a detokenised payment token received from the merchant processing device) with the pre-authorised credentials and selectively authorising the transaction based upon the outcome of the comparison. In one example, this includes authorising the transaction if the user account referenced by the payment token is the same as the account provided at pre-authorisation. In any event, pre-authorisation is discussed further below.

In a further example of a transaction system for performing a transaction relating to delivery of goods to a user by a delivery vehicle, the transaction system includes a delivery vehicle processing device 120 of the delivery vehicle that provides delivery parameters to a client device 130, where the delivery parameters are indicative of the respective delivery. The delivery vehicle processing device 120 receives a payment token from the client device 130, where the client device 130 obtains the payment token from one or more payment processing devices 110 using the delivery parameters and an account indication indicative of a user account associated with the user, the payment token being associated with the user account and one or more delivery parameters. Additionally, the delivery vehicle processing device 120 provides the payment token to a merchant processing device 140, the merchant processing device 140 obtaining a payment authorisation response from the payment processing device 110 using the payment token. The delivery vehicle processing device 120 receives a delivery notification from the merchant processing device 140 in response to the payment authorisation response, and controls the delivery vehicle in accordance with the delivery notification to selectively provide the goods to the user depending on the outcome of the authorisation.

In this example, the transaction processing system may include any one or more of the additional features described herein. For example, as discussed above the delivery vehicle processing device 120 may optionally provide the delivery parameters from the delivery device using a first wireless communications protocol, and receive the payment token to the delivery device using a second wireless communications protocol. Typically, the first wireless communications protocol includes Bluetooth™ Low Energy (BLE) protocol and the second wireless communications protocol includes Near Field Communication (NFC) protocol, however any suitable communications protocols may be used.

In one example, the delivery vehicle processing device 120 receives the payment token from the client device 130 based on a proximity of the delivery device and the client device 130. Whilst this may be achieved in any suitable manner, in the preferred embodiment receipt of the payment token occurs in response to the client device 130 being “tapped” within range of a reader associated with the delivery vehicle, and utilising NFC.

In a further example, the delivery vehicle processing device 120 provides the delivery parameters to the client device based on a proximity of the delivery device and the client device 130. This may be achieved in any suitable manner, and in one example includes providing the delivery parameters based upon comparing the difference between the locations (e.g. geolocations) of the delivery vehicle and client device 130 with a predetermined distance.

In one instance, the delivery vehicle processing device 120 communicates with a merchant application executed by the client device 130 to determine if the user is an intended recipient. This may be achieved in any suitable manner, and in some examples includes comparing a recipient indication with parameters provided by the merchant application. For example, the delivery vehicle processing device 120 may compare a client device 130 identifier, such as a device fingerprint or unique identifier, or an intended recipient identifier associated with the user, such as a user identifier (ID) or username, with corresponding parameters received from the merchant application, in order to determine if the user is an intended recipient. Alternatively, this comparison may be performed by the merchant application.

In one example, the delivery vehicle processing device 120 receives at least some delivery parameters from the merchant processing device 140 including a payment amount, a delivery destination, and a recipient indication indicative of at least one of the user and the client device 130 of the user. The delivery parameters may be received in any suitable manner, including via a communications network, such as Wi-Fi, or the like. In one example, the delivery parameters are provided prior to dispatch, and this may be achieved using wired or wireless communication to the delivery vehicle processing device 120 (e.g. the delivery device may be plugged directly into the merchant processing device in order to upload the parameters). Alternatively the delivery parameters may be provided to the delivery device processing system 120 following dispatch, for example, wirelessly. This is particularly beneficial as it allows the delivery vehicle to be forwarded and/or redirected to a further user without having to return to the merchant processing device 140.

Whilst the examples herein refer to a delivery vehicle providing goods to a user, it will be appreciated that the delivery vehicle may include multiple batches of goods, where each batch is for delivery to one of multiple users. Thus, the delivery vehicle processing device 120 may receive delivery parameters relating to multiple intended recipients, and in addition the delivery parameters may include a goods identifier associating goods to a user. Optionally, in this example the delivery vehicle processing device 120 may perform scheduling, route mapping, and/or dynamic optimisation of deliveries based upon locations, priorities, and the like associated with each of the multiple users.

As discussed above, the delivery vehicle may include any suitable vehicle, and in one example is an at least partially autonomous unmanned aerial vehicle. In this regard, it will be appreciated that the above described payment process does not require human intervention other than by the user, hence making this ideal for use with automated delivery processes/procedures.

A further example of a transaction system for performing a transaction relating to delivery of goods to a user by a delivery vehicle, includes a client device 130 that receives delivery parameters from a delivery vehicle processing device 120 of the delivery vehicle, where the delivery parameters are indicative of the respective delivery.

The client device 130 of this example provides a user payment request to one or more payment processing devices 110, where the user payment request is indicative of the delivery parameters and an account indication indicative of a user account associated with the user. The client device 130 receives a payment token from the payment processing device 110, the payment token being associated with at least the user account and one or more delivery parameters. The client device 130 transfers the payment token to the delivery vehicle processing device 120, the delivery vehicle processing device 120 transferring the payment token to a merchant processing device 140, the merchant processing device 140 using the payment token to obtain a payment authorisation response from the payment processing device 110 and cause the delivery vehicle to selectively provide the goods depending on the outcome of the authorisation.

Further features of this system may include one or more of the features described herein. For example, the client device 130 may execute a merchant application and a payment application such as described above, and in further detail below.

A further example of a transaction system for performing a transaction relating to delivery of goods to a user by a delivery vehicle includes a merchant processing device 140, one or more payment processing devices 110, a delivery vehicle including a delivery vehicle processing device 120, and a client device 130 of the user.

In use, the delivery vehicle processing device 120 provides delivery parameters to the client device 130, where the delivery parameters are indicative of the respective delivery. The client device 130 provides a user payment request to the payment processing device 110, where the user payment request is indicative of the delivery parameters and an account indication indicative of a user account associated with the user.

The payment processing device 110 determines a payment token associated with the user account and one or more of the delivery parameters, and provides the payment token to the client device 130. The client device 130 provides the payment token to the delivery vehicle processing device 120, and the delivery vehicle processing device 120 provides the payment token to the merchant processing device 140.

The merchant processing device 140 provides the payment token to the payment processing device 110, and the payment processing device 110 uses the payment token to selectively authorise the transaction and provides a payment authorisation response to the merchant processing device 140.

The merchant processing device 140 uses the payment authorisation response to provide a delivery notification to the delivery vehicle processing device 120, and the delivery vehicle processing device 120 controls the delivery vehicle in accordance with the delivery notification to selectively provide the goods to the user depending on the outcome of the authorisation.

In addition, the transaction system described in this example may include any of the further features described herein.

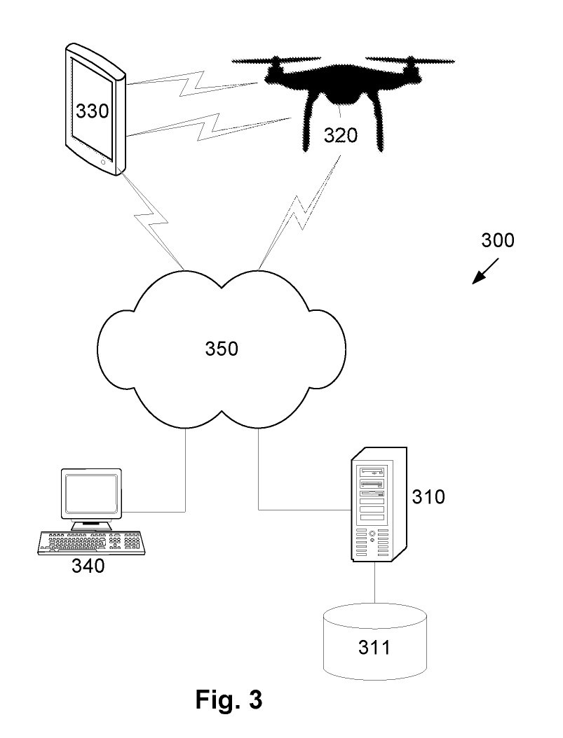

FIG. 3 shows a further example of a transaction system for performing a transaction relating to delivery of goods to a user by a delivery vehicle. In this example, the delivery vehicle is a drone, however as discussed above, any suitable type of vehicle may be used. In any event, the system 300 includes a drone including drone processing system 320, a client device 330 running a merchant application and a payment application such as a mobile wallet application, a communication network 350, a merchant processing device 340, and a payment processing device 310 in communication with a database 311.

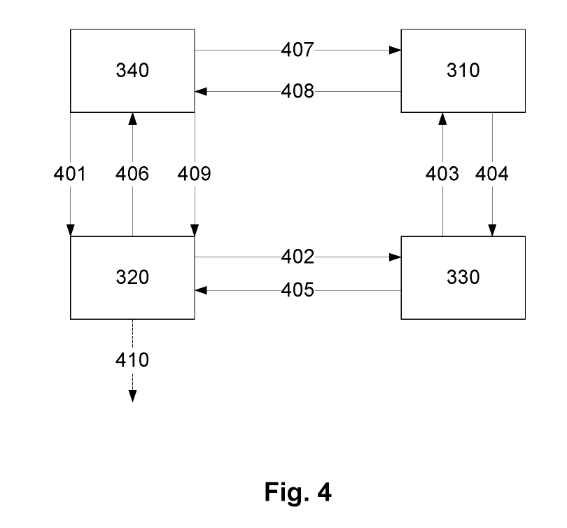

FIG. 4 shows a dataflow diagram illustrating one example of the dataflow between the components of the transaction system of FIG. 3.

In particular, at 401 the merchant device 340 provides transaction details to the drone device 320 in relation to the payment amount, recipient (such as recipient geolocation, a client device identifier, etc.), and merchant identification (ID). The drone uses the recipient geolocation to navigate to, and locate the client device.

When the drone device 320 is within a predetermined distance of the client device 330, the client device 330 is notified about the arrival of the drone via the merchant application. At 402 the drone device 320 uses a Bluetooth™ Low Energy (BLE) communication protocol to provide delivery parameters (DP) such as a Drone ID (DID), Merchant ID (MID), destination geolocation (e.g. longitude and latitude), delivery timestamp (for example, in a format DDMMYY.HR.Min.Sec), and an amount chargeable to the client's merchant application.

The merchant application in turn invokes the mobile wallet application on the client device 330, providing the abovementioned delivery parameters to the wallet application. Whilst any type of wallet application may be used, such as MasterPass, Apple™ Pay, Google™ Wallet, or the like, in some instances the application is provided by a user's banking institution.

At 403 the mobile wallet application provides a payment request including the delivery parameters and a personal account number (PAN), or other indication of a user's account information, to the payment processing system 310. The payment processing system 310 then creates a mapping of the delivery parameters and PAN to provide a payment token, such as a Drone Transaction PAN (DTPAN), and sends it back to the user's mobile wallet application at 404. In this example, the DTPAN is unique to the payment transaction and cannot be utilised for payments outside of the associated drone. As discussed above, this is particularly beneficial as it provides additional security for the user's account information as the token provides only a one-time authorisation associated to the selected drone, and therefore cannot be replicated by a third party for additional transactions. The DTPAN may then be stored in the mobile wallet application for use in due course.

The user may be prompted by the drone or merchant application to “tap” their device 330 to a contactless technology reader located on the drone in order to complete the payment process. In this regard, tapping of the client device utilises Near Field Communication (NFC) with the drone device 320 in order to provide the drone device 320 with the DTPAN.

In one example, the drone device 320 utilises the contactless technology reader to complete the payment transaction utilising the EMV contactless transaction standard. The EMV Contactless Specifications are available at https://www.emvco.com/specifications.aspx?id=21 and are incorporated herein by reference in their entirety for all purposes. In this example, the transaction may be finalised by the DTPAN being provided from the drone device 320 to the merchant device 340 at 406, which in turn provides the DTPAN to a payment processing system 310 at 407, and this will be discussed in further detail below.

The payment processing system 310 then authorises the payment based upon the DTPAN, and provides a response to the merchant at 408. The authorisation response is then provided to the drone device 320 at 409, and if authorisation is successful the drone releases the goods to the user at 410.

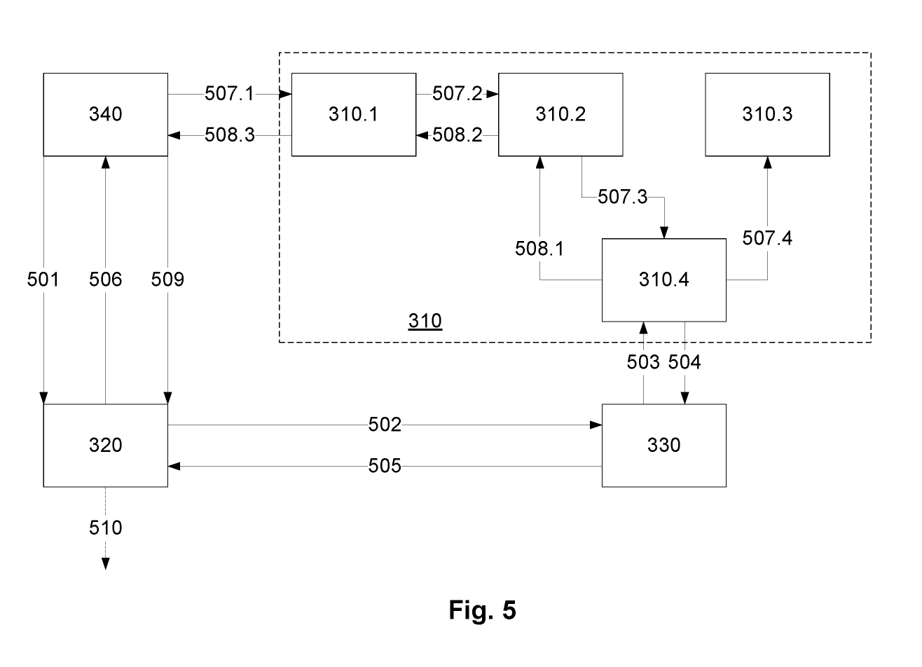

FIG. 5 shows a further example of a dataflow diagram illustrating the dataflow between the components of the transaction system of FIG. 3. In this example, the payment processing system 310 includes a payment gateway 310.1, acquirer 310.2, issuer 310.3 and card network 310.4, however it will be appreciated that in some examples the payment processing system 310 is any one of the payment gateway 310.1, acquirer 310.2, issuer 310.3 and card network 310.4, and more typically the payment processing system 310 is the card network 310.4.

In any event, in this example dataflow at 501, 502, 505, 506 and 509 proceeds largely inline with the dataflow described in relation to corresponding reference numerals 401, 402, 405, 406 and 409 in FIG. 4.

At 503, the mobile wallet application provides the payment request to the card network 310.4, which creates a mapping of the delivery parameters and PAN to provide the DTPAN, and sends it back to the user's mobile wallet application at 504.

At 507.1, the merchant processing device 340 forwards the payment token to the card network 310.4 via the payment gateway 310.1 and acquirer 310.2 at 507.2 and 507.3 respectively. The card network 310.4 authorises the transaction, at least in part by comparing the DT-PAN received via the merchant and the DT-PAN created in response to the user payment request at 503. An authorisation request is then transmitted at 507.4 to the issuer 310.3. The issuer system 310.3 checks that the user's account is in good standing and has sufficient account balance to cover the payment amount and if so, sends an authorisation response provided to the merchant 340 via the card network 310.4, acquirer 310.2 and payment gateway 310.1 at 508.1, 508.2 and 508.3, respectively. The user's account (held at issuer 310.3) is later debited by the payment amount, and the merchant's account (held at acquirer 310.2) is correspondingly credited (minus any applicable fees charged by payment gateway 310.1, acquirer 310.2, card network 310.4 and/or issuer 310.3) in clearance and settlement processes which are known in the art and not described in further detail here.

In any event, the dataflow at 507 and 508 largely corresponds to standard EMV routing as described in the EMV Specifications (especially the EMV Contactless Specifications referenced above), with the exception that the payment token is the DT-PAN rather a standard payment token. In this regard, the card network 310.4 performs the additional non-standard step of comparing delivery parameters tokenised in the DT-PAN with those received via the user payment request at 503.

In a further example, the payment transaction may be pre-authorised prior to dispatch of the goods. In this regard, when the user creates an order for the goods using the merchant application on the client device, the user selects an account to use for payment. In one example, this selection involves the user selecting a tokenised card from a MasterCard™ Digital Enablement Service (MDES)/Host Card Emulation (HCE)-enabled wallet application.

The selected payment account is then pre-authorised for the final payment amount, to ensure the account is in good standing and has sufficient balance prior to dispatch of the goods. This may be achieved in any suitable manner, and in one example includes providing the tokenised card to an issuer via a payment gateway, acquirer and card network. This process of pre-authorisation is known in the art and is not described here in further detail.

### Client Device 130

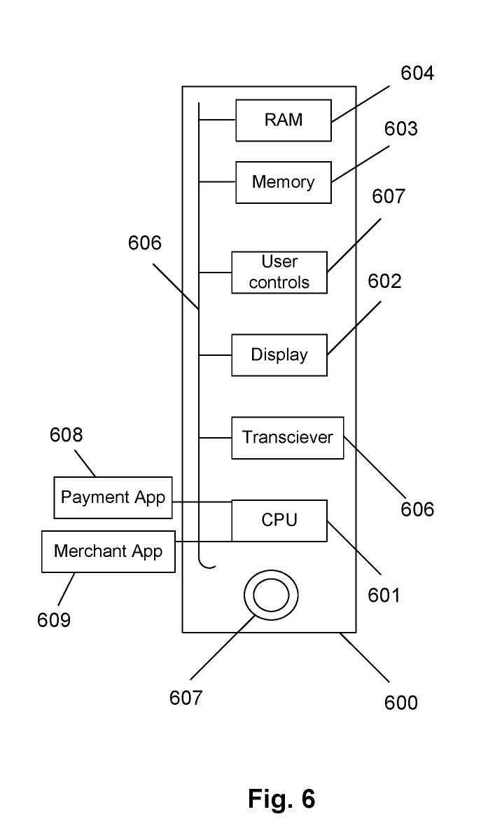

The client device 130 of any of the examples herein may be a handheld computer device such as a smart phones or a PDA such as one manufactured by Apple™, LG™, HTC™, Research In Motion™, or Motorola™. The client device 130 may include a mobile computer such as a tablet computer. An exemplary embodiment of a client device 600 is shown in FIG. 6. As shown, the device 600 includes the following components in electronic communication via a bus 606:
1. a display 602;
2. non-volatile memory 603;
3. random access memory (“RAM”) 604;
4. N processing components 601;
5. a transceiver component 602 that includes N transceivers; and
6. user controls 607.

Although the components depicted in FIG. 6 represent physical components, FIG. 6 is not intended to be a hardware diagram; thus many of the components depicted in FIG. 6 may be realized by common constructs or distributed among additional physical components. Moreover, it is certainly contemplated that other existing and yet-to-be developed physical components and architectures may be utilized to implement the functional components described with reference to FIG. 6.

The display 602 generally operates to provide a presentation of content to a user, and may be realized by any of a variety of displays (e.g., CRT, LCD, HDMI, micro-projector and OLED displays). And in general, the non-volatile memory 603 functions to store (e.g., persistently store) data and executable code including code that is associated with the functional components of a browser component and applications, and in one example, the payment and merchant applications 608, 609. In some embodiments, for example, the non-volatile memory 603 includes bootloader code, modem software, operating system code, file system code, and code to facilitate the implementation of one or more portions of the payment and merchant applications 608, 609 as well as other components well known to those of ordinary skill in the art that are not depicted for simplicity.

In many implementations, the non-volatile memory 603 is realized by flash memory (e.g., NAND or ONENAND memory), but it is certainly contemplated that other memory types may be utilized as well. Although it may be possible to execute the code from the non-volatile memory 603, the executable code in the non-volatile memory 603 is typically loaded into RAM 604 and executed by one or more of the N processing components 601.

The N processing components 601 in connection with RAM 604 generally operate to execute the instructions stored in non-volatile memory 603 to effectuate the functional components. As one of ordinarily skill in the art will appreciate, the N processing components 601 may include a video processor, modem processor, DSP, graphics processing unit (GPU), and other processing components.

The transceiver component 606 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

### Delivery Vehicle Processing Device 120

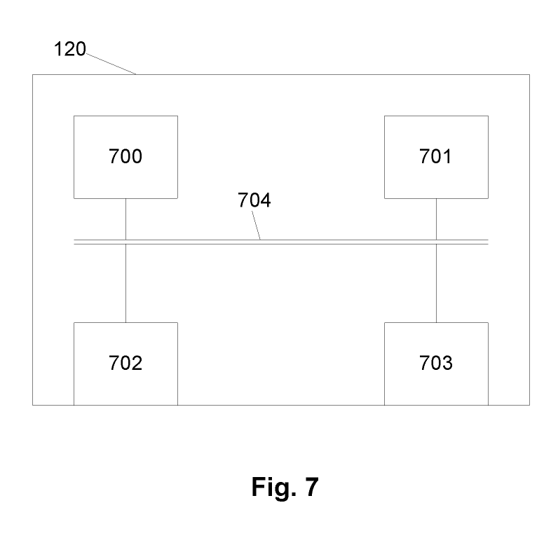

A suitable delivery vehicle processing device for use in the transaction system described in anyone of the above examples is shown in FIG. 7. In this example, the delivery vehicle processing device 120 includes at least one microprocessor 700, a memory 701, an first external interface 702, and an optional second external interface 703, interconnected via a bus 704 as shown. Optionally, the device 120 may also include one or more input/output (I/O) devices, such as a display, keyboard, touchscreen, and the like. In this example the first and second external interfaces 702, 703 can be utilised by the delivery vehicle processing device 120 when communicating with peripheral devices, such as the client device 130, communications networks, merchant processing device 140, databases, other storage devices, or the like. Although only two external interfaces 702, 703 are shown, this is for the purpose of example only, and in practice multiple interfaces using various methods (eg. Ethernet, serial, USB, wireless, Bluetooth™ Low Energy (BLE), Near Field Communication (NFC), or the like) may be provided.

In use, the microprocessor 700 executes instructions in the form of applications software stored in the memory 701 to allow communication with the merchant processing device 140, for example to receive delivery parameters, and the client device 130, for example to receive the payment token.

Accordingly, it will be appreciated that the delivery vehicle processing device 120 may be formed from any suitable processing system associated with the delivery vehicle, such as any electronic processing device, including a microprocessor, microchip processor, logic gate configuration, firmware optionally associated with implementing logic such as an FPGA (Field Programmable Gate Array), or any other electronic device, system or arrangement. However, the delivery vehicle processing device 120 may also be formed from a suitably programmed PC, Internet terminal, lap-top, or hand-held PC, a tablet, or smart phone, or the like. Thus, in one example, the processing system 210 is a standard processing system such as an Intel Architecture based processing system, which executes software applications stored on non-volatile (e.g., hard disk) storage, although this is not essential.

### Payment Processing Device 110 and Merchant Processing Device 140

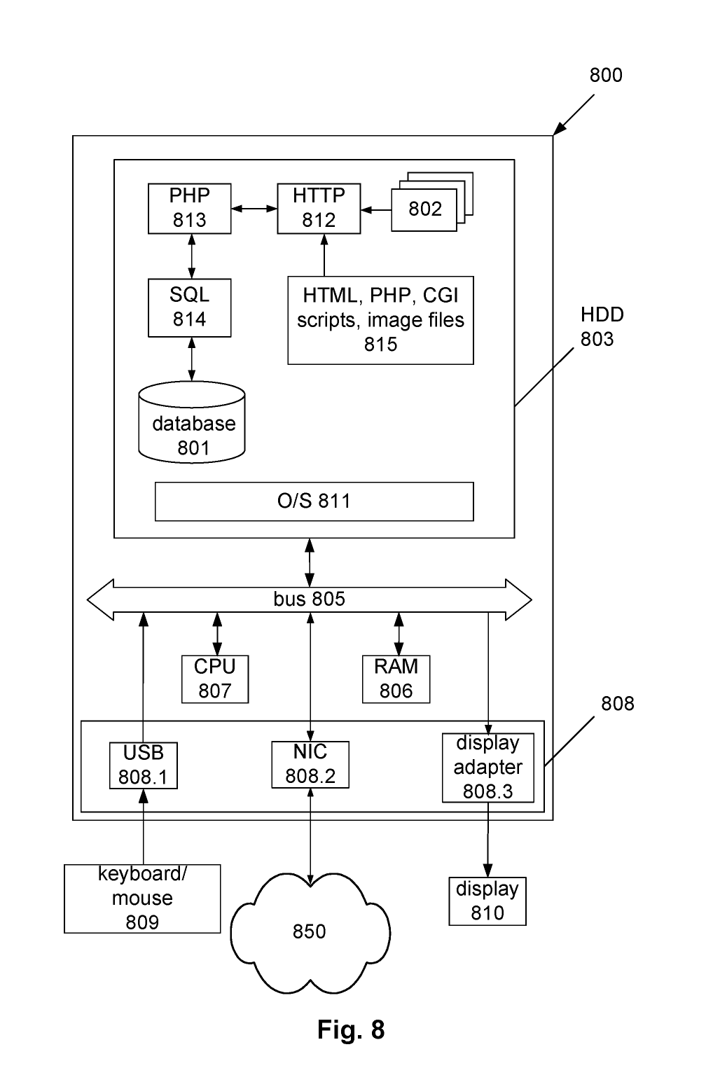

The payment processing device and the merchant processing device of any of the examples herein may be formed of any suitable processing device, and one such suitable device is shown in FIG. 8. In this example, a processing device is provided by a server 800 in communication with a database 801, as shown in FIG. 8. The computer system 800 is able to communicate with the delivery vehicle processing device 120, client device 130, the payment processing device 110 and/or merchant processing device 140, and/or other processing devices, as required, over a communications network 850 using standard communication protocols.

The components of the system 800 can be configured in a variety of ways. The components can be implemented entirely by software to be executed on standard computer server hardware, which may comprise one hardware unit or different computer hardware units distributed over various locations, some of which may require the communications network 850 for communication. A number of the components or parts thereof may also be implemented by application specific integrated circuits (ASICs) or field programmable gate arrays.

In the example shown in FIG. 8, the computer system 800 is a commercially available server computer system based on a 32 bit or a 64 bit Intel architecture, and the processes and/or methods executed or performed by the computer system 800 are implemented in the form of programming instructions of one or more software components or modules 802 stored on non-volatile (e.g., hard disk) computer-readable storage 803 associated with the computer system 800. At least parts of the software modules 802 could alternatively be implemented as one or more dedicated hardware components, such as application-specific integrated circuits (ASICs) and/or field programmable gate arrays (FPGAs).

The computer system 800 includes at least one or more of the following standard, commercially available, computer components, all interconnected by a bus 805:
1. random access memory (RAM) 806;
2. at least one computer processor 807, and
3. external computer interfaces 808:
   a. universal serial bus (USB) interfaces 808.1 (at least one of which is connected to one or more user-interface devices, such as a keyboard, a pointing device (e.g., a mouse 809 or touchpad),
   b. a network interface connector (NIC) 808.2 which connects the computer system 800 to a data communications network, such as the Internet 850; and
   c. a display adapter 808.3, which is connected to a display device 810 such as a liquid-crystal display (LCD) panel device.

The computer system 800 includes a plurality of standard software modules, including:
1. an operating system (OS) 811 (e.g., Linux or Microsoft Windows);
2. web server software 812 (e.g., Apache, available at http://www.apache.org);
3. scripting language modules 813 (e.g., personal home page or PHP, available at http://www.php.net, or Microsoft ASP); and
4. structured query language (SQL) modules 814 (e.g., MySQL, available from http://www.mysql.com), which allow data to be stored in and retrieved/accessed from an SQL database 801.

Together, the web server 812, scripting language 813, and SQL modules 814 provide the computer system 800 with the general ability to allow users of the Internet 950 with standard computing devices equipped with standard web browser software to access the computer system 800 and in particular to provide data to and receive data from the database 801. It will be understood by those skilled in the art that the specific functionality provided by the system 800 to such users is provided by scripts accessible by the web server 812, including the one or more software modules 802 implementing the processes performed by the computer system 800, and also any other scripts and supporting data 815, including markup language (e.g., HTML, XML) scripts, PHP (or ASP), and/or CGI scripts, image files, style sheets, and the like.

The boundaries between the modules and components in the software modules 802 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field- programmable gate array (FPGA), the design of a gate array or full-custom application-specific integrated circuit (ASIC), or the like.

Each of the steps of the processes performed by the computer system 800 may be executed by a module (of software modules 802) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The computer system 800 normally processes information according to a program (a list of internally stored instructions such as a particular application program and/or an operating system) and produces resultant output information via input/output (I/O) devices 808. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

In other examples, such as described above, the payment processing device is formed of multiple computer systems interacting, for example, via a distributed network arrangement. As distributed networking is known in the art, it will not be described further in more detail.

Thus, the abovementioned examples provide a transaction system for performing a transaction relating to delivery of goods to a user by a delivery vehicle, where the transaction system allows for payment finalisation at point of delivery whilst providing additional security for a user's account information. Thus the system offers a reduction in the risk of incorrect delivery, and misappropriation of goods and/or user banking credentials.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1) A transaction system for performing a transaction relating to delivery of goods to a user by a delivery vehicle, the transaction system including at least one electronic payment processing device that:
a) receives a user payment request from a client device of the user, the user payment request being indicative of:
i) delivery parameters received by the client device from a delivery vehicle processing device, the delivery parameters being indicative of the respective delivery; and,
ii) an account indication indicative of a user account associated with the user;
b) determines a payment token associated with the user account and at least one of the delivery parameters;
c) provides the payment token to the client device, the client device providing the payment token to a merchant processing device via the delivery vehicle processing device;
d) receives the payment token from the merchant processing device; and,
e) uses the payment token to selectively authorise the transaction, so that the goods are selectively provided to the user depending on the outcome of the authorisation.

2) A transaction system according to claim 1, wherein the at least one electronic payment processing device provides a payment authorisation response to the merchant processing device, the merchant processing device using the payment authorisation response to cause the delivery vehicle to selectively provide the goods to the user depending on the outcome of the authorisation.

3) A transaction system according to claim 1, wherein the at least one electronic payment processing device:
a) receives a merchant payment request including:
i) at least one delivery parameter; and,
ii) the payment token;
b) compares the at least one delivery parameter of the merchant payment request to a corresponding delivery parameter of the user payment request; and,
c) selectively authorises the transaction based on results of the comparison.

4) A transaction system according to claim 1, wherein the at least one electronic payment processing device authorises the transaction by:
a) determining the user account using the payment token; and,
b) causing the user account to be debited in accordance with the payment amount.

5) A transaction system according to claim 1, wherein the at least one electronic payment processing device sends an authorisation request to an issuer, the authorisation request including an indication of the user account and the payment amount, thereby causing the issuer to debit the user account by the payment amount.

6) A transaction system according to claim 1, wherein the at least one electronic payment processing device receives the payment token from the merchant processing device via at least one of:
a) a payment gateway processing device; and,
b) an acquirer processing device.

7) A transaction system according to claim 1, wherein the at least one electronic payment processing device:
a) retrieves a previously stored unique payment token;
b) generates a new unique payment token;
c) associates the payment token with the user account and the at least one delivery parameter; and,
d) generates a payment token based on the user account and the at least one delivery parameter.

8) A transaction system according to claim 1, wherein the client device executes a merchant application and a payment application, and wherein:
a) the merchant application:
i) receives the delivery parameters; and,
ii) provides the delivery parameters to the payment application; and,
b) the payment application:
i) generates the user payment request;
ii) provides the user payment request to the at least one payment processing system;
iii) receives the payment token; and,
iv) provides the payment token to the delivery vehicle processing device.

9) A transaction system according to claim 1, wherein the client device:
a) receives the delivery parameters from the delivery device using a first wireless communications protocol; and,
b) provides the payment token to the delivery device using a second wireless communications protocol.

10) A transaction system according to claim 9, wherein the first wireless communications protocol includes Bluetooth™ Low Energy (BLE) protocol.

11) A transaction system according to claim 1, wherein the second wireless communications protocol includes Near Field Communication (NFC) protocol.

12) A transaction system according to claim 1, wherein the at least one payment processing device is part of a host card emulation system.

13) A transaction system according to claim 1, wherein the delivery parameters include at least one of:
a) a delivery vehicle identifier associated with the delivery vehicle;
b) a merchant identifier associated with the merchant;
c) a payment amount;
d) a delivery destination;
e) a delivery time; and,
f) a recipient indication indicative of at least one of the user and the client device of the user.

14) A method for performing a transaction relating to delivery of goods to a user by a delivery vehicle, the method including:
a) receiving a user payment request from a client device of the user, the user payment request being indicative of:
i) delivery parameters received by the client device from a delivery vehicle processing device, the delivery parameters being indicative of the respective delivery; and,
ii) an account indication indicative of a user account associated with the user;
b) determining a payment token associated with the user account and at least one of the delivery parameters;
c) providing the payment token to the client device, the client device providing the payment token to a merchant processing device via the delivery vehicle processing device;
d) receiving the payment token from the merchant processing device; and,
e) using the payment token to selectively authorise the transaction, so that the goods are selectively provided to the user depending on the outcome of the authorisation.

15) A transaction system for performing a transaction relating to delivery of goods to a user by a delivery vehicle, the transaction system including a delivery vehicle processing device of the delivery vehicle that:
a) provides delivery parameters to a client device, the delivery parameters being indicative of the respective delivery;
b) receives a payment token from the client device, wherein the client device obtains the payment token from at least one payment processing device using the delivery parameters and an account indication indicative of a user account associated with the user, the payment token being associated with the user account and at least one of the delivery parameters;
c) provides the payment token to a merchant processing device, the merchant processing device obtaining a payment authorisation response from the at least one payment processing device using the payment token;
d) receives a delivery notification from the merchant processing device in response to the payment authorisation response; and,
e) controls the delivery vehicle in accordance with the delivery notification to selectively provide the goods to the user depending on the outcome of the authorisation.

16) A transaction system according to claim 15, wherein the delivery vehicle processing device:
a) provides the delivery parameters from the delivery device using a first wireless communications protocol; and,
b) receives the payment token to the delivery device using a second wireless communications protocol.

17) A transaction system according to claim 16, wherein the first wireless communications protocol includes Bluetooth™ Low Energy (BLE) protocol.

18) A transaction system according to claim 16, wherein the second wireless communications protocol includes Near Field Communication (NFC) protocol.

19) A transaction system according to claim 15, wherein the delivery vehicle processing device receives the payment token from the client device based on a proximity of the delivery device and the client device.

20) A transaction system according to claim 15, wherein the delivery vehicle processing device provides the delivery parameters to the client device based on a proximity of the delivery device and the client device.

21) A transaction system according to claim 15, wherein the delivery vehicle processing device communicates with a merchant application executed by the client device to determine if the user is an intended recipient.

22) A transaction system according to claim 15, wherein the delivery vehicle processing device receives at least some delivery parameters from the merchant processing device, including:
a) a payment amount;
b) a delivery destination; and,
c) a recipient indication indicative of at least one of the user and the client device of the user.

23) A transaction system according to claim 1, wherein the delivery vehicle is an at least partially autonomous unmanned aerial vehicle.

24) A transaction system for performing a transaction relating to delivery of goods to a user by a delivery vehicle, the transaction system including a client device that:
a) receives delivery parameters from a delivery vehicle processing device of the delivery vehicle, the delivery parameters being indicative of the respective delivery;
b) provides a user payment request to at least one payment processing device, the user payment request being indicative of:
i) the delivery parameters; and,
ii) an account indication indicative of a user account associated with the user;
c) receives a payment token from the at least one payment processing device, the payment token being associated with the user account and at least one of the delivery parameters; and,
d) transfers the payment token to the delivery vehicle processing device, the delivery vehicle processing device transferring the payment token to a merchant processing device, the merchant processing device using the payment token to obtain a payment authorisation response from the at least one payment processing device and cause the delivery vehicle to selectively provide the goods depending on the outcome of the authorisation.

25) A transaction system according to claim 24, wherein the client device executes a merchant application and a payment application, and wherein:
a) the merchant application:
i) receives the delivery parameters; and,
ii) provides the delivery parameters to the payment application; and,
b) the payment application:
i) generates the user payment request;
ii) provides the user payment request to the at least one payment processing system;
iii) receives the payment token; and,
iv) provides the payment token to the delivery vehicle processing device.

26) A transaction system for performing a transaction relating to delivery of goods to a user by a delivery vehicle, the transaction system including:
a) a merchant processing device;
b) at least one payment processing device;
c) a delivery vehicle including a delivery vehicle processing device; and,
d) a client device of the user, wherein in use:
i) the delivery vehicle processing device provides delivery parameters to the client device, the delivery parameters being indicative of the respective delivery;
ii) the client device provides a user payment request to the at least one payment processing device, the user payment request being indicative of:
(1) the delivery parameters; and,
(2) an account indication indicative of a user account associated with the user;
iii) the at least one payment processing device:
(1) determines a payment token associated with the user account and at least one of the delivery parameters;
(2) provides the payment token to the client device;
iv) the client device provides the payment token to the delivery vehicle processing device;
v) the delivery vehicle processing device provides the payment token to the merchant processing device;
vi) the merchant processing device provides the payment token to the at least one payment processing device;
vii) the at least one payment processing device:
(1) uses the payment token to selectively authorise the transaction; and,
(2) provides a payment authorisation response to the merchant processing device;
viii) the merchant processing device uses the payment authorisation response to provide a delivery notification to the delivery vehicle processing device; and,
ix) the delivery vehicle processing device controls the delivery vehicle in accordance with the delivery notification to selectively provide the goods to the user depending on the outcome of the authorisation.
